(19) United States
(12) Patent Application Publication
(10) Pub. No.: US 2002/0154240 A1
(43) Pub. Date: Oct. 24, 2002

(54) Imaging position detecting device and program therefor

(76) Inventors: Keiji Tamai, Osaka (JP); Masataka Hamada, Osaka (JP)

Correspondence Address: MCDERMOTT, WILL & EMERY, 600 13th Street, N.W., Washington, DC, 20005-3096, US

(21) Appl. No.: 10/106,818

(22) Filed: Mar. 27, 2002

(30) Foreign Application Priority Data
Mar. 30, 2001 (JP) 2001-100889

(51) Int. Cl. H04N 5/232

(52) U.S. Cl. 348/345; 348/349

(57) ABSTRACT

A method is put into practice whereby a particular portion of a subject is detected in a plurality of images taken with different distances from a taking lens so that the position in which the subject is imaged is detected on the basis of the positions of the particular portion detected in those images and the distances from the taking lens to the positions in which those images were taken. Before the positions of the subject in the plurality of images are detected, differences in position of the subject among those images that result from those images being taken at different times and differences in size of the subject and in brightness among those images that result from varying distances from the taking lens are all corrected. A program for executing this process of imaging position detection is implemented in a digital camera to quicken the automatic focusing performed therein.

This application is based on Japanese Patent Application No. 2001-100889 filed on Mar. 30, 2001, the contents of which are hereby incorporated by reference.

### BACKGROUND OF THE INVENTION

1. Field of the Invention

The present invention relates to a device for detecting the position in which a taking lens images a subject, and to a program for use in such a device. These device and method are used, for example, for focus adjustment in a camera.

2. Description of the Prior Art

Digital cameras and video cameras are provided with an autofocus (AF) function that permits the taking lens thereof to be automatically focused on a subject. An AF function is typically realized by repeatedly imaging the subject and meanwhile varying the focus of the taking lens in the direction in which higher contrast is obtained in the image formed. In recent years, to obtain higher-definition images in such cameras, they have come to be equipped with increasingly high-resolution image sensors, and accordingly there have been increasing demand for quicker focusing of the taking lens on the subject.

Under these circumstances, Japanese Patent Application Laid-Open No. H10-206150 proposes a method of finding the position in which the subject is imaged. According to this method, a plurality of images are taken with varying distances between the taking lens and the image sensor, and the position in which the subject is imaged is found on the basis of a particular portion of the subject as observed in the images so formed and the distance between the taking lens and the image sensor as observed when those images were taken. Now that the imaging position of the subject is found, the distance to the subject can be calculated readily on the basis of the focal length of the taking lens. Thus, this method is useful for quick focus adjustment.

However, although the aforementioned publication discloses the basic principles of the method, it leaves the following problems to be solved before the method is put into practice:

(1) While the plurality of images are being taken, time passes and thus the positions of the subject and the camera relative to each other vary. Without giving consideration to this, it is not possible to find the imaging position accurately.

(2) With varying distances between the taking lens and the image sensor, the subject appears in varying sizes in the plurality of images. This needs to be corrected but, depending on the design of the taking lens, the size of the image taken (image height) is not proportional to the distance between the taking lens and the image sensor.

(3) A portion of the subject that appears with identical brightness in the plurality of images is regarded as an identical portion. However, in general, the farther from the taking lens, the dimmer the image, and therefore a particular portion of the subject does not appear with identical brightness in the plurality of images.

(4) When the taking lens is moved to vary the distance between the taking lens and the image sensor, depending on the design of the taking lens, the distance traveled by the taking lens does not always equal the distance traveled by the imaging plane.

(5) The publication gives no specific distances between the taking lens and the image sensor to be set when the plurality of images are taken.

(6) The publication gives no specific shooting conditions, such as aperture values, to be set when the plurality of images are taken.

### SUMMARY OF THE INVENTION

An object of the present invention is to provide an imaging position detecting device that puts the method disclosed in the aforementioned publication into practice, and to provide a program for use in such a device.

To achieve the above object, according to one aspect of the present invention, an imaging position detecting device is provided with: an image taker for taking a plurality of images with varying relative distances to a taking lens; a corrector for correcting differences among the plurality of images that arise while the plurality of images are being taken; a first detector for detecting a particular portion of a subject in the plurality of images as corrected by the corrector; and a second detector for detecting the imaging position in which the taking lens images the subject on the basis of the positions of the particular portion in the plurality of image as detected by the first detector and the relative distances.

With this device, even when differences arise between the plurality of images as a result of the movement of the subject or camera shake while those images are being taken, first those differences are corrected, and then the particular portion of the subject is detected. Thus, the imaging position of the subject can be detected accurately.

As the particular portion of the subject, it is possible to use a portion of the subject that appears with identical brightness in the plurality of images, or alternatively it is possible to use a portion of the subject that exhibits much variation in brightness among the plurality of images. Either way, the recognition of the particular portion is made easier.

It is advisable to correct differences in position of the subject among the plurality of images that result from the variation of the positions of the subject and the taking lens relative to each other. Differences in position of the subject among the plurality of images are a chief cause that lowers detection accuracy. Thus, eliminating this cause makes it possible to detect the imaging position accurately. In this case, it is advisable to find correlation among the plurality of images and, on the basis of the correlation found, correct the differences in position of the subject among the plurality of images.

It is advisable to first correct differences in size of the subject among the plurality of images that result from the varying relative distances to the taking lens, and then corrects the differences in position of the subject among the plurality of images. Differences arise in the size of the subject among the plurality of images according to the distance to the taking lens. Correcting these differences in size first makes it possible to evaluate differences in position accurately, and thus to correct these accurately.

Here, it is advisable to find correlation among the plurality of images among which differences in size of the subject have already been corrected. This makes it possible to correct differences in position accurately.

It is advisable to correct differences in size of the subject among the plurality of images that result from the varying relative distances to the taking lens. Differences in size of the subject among the plurality of images are another chief cause that lowers detection accuracy. Thus, eliminating this cause makes it possible to detect the imaging position accurately. Even with a taking lens in which the size of the subject as observed in the image is not proportional to the distance from the taking lens, it is possible to make corrections according to the characteristics thereof, and thus to detect the imaging position without fail and with high accuracy.

It is advisable to correct differences in brightness among the plurality of images that result from the varying relative distances to the taking lens. The farther from the taking lens, the dimmer the image. Thus, a particular portion of the subject does not appear with identical brightness in the plurality of images. Conversely, portions that appear with identical brightness in the plurality of images do not correspond to an identical portion of the subject. Under these conditions, detecting portions with identical brightness among the plurality of images does not result in accurate detection of the imaging position of the subject. In this device, however, first differences in brightness are corrected and then portions with identical brightness are detected in the plurality of images. Thus, the detected portions correspond to an identical portion of the subject. This makes it possible to detect the imaging position accurately.

It is advisable to design the corrector to correct differences among the plurality of images according to information on the characteristics of the taking lens. This makes it possible to make various corrections as mentioned above according to the design of the taking lens. For example, even with a taking lens in which the size of the image is not proportional to the distance from the taking lens, it is possible to make adequate corrections.

In this case, the taking lens may be dismountably mounted on the imaging position detecting device. For example, information on the characteristics of the taking lens is stored in the taking lens itself, and the information is fed from the taking lens to the corrector. Making the taking lens dismountable, i.e. interchangeable, makes the device easier to use, and ensures proper corrections with any taking lens mounted. Thus, it is possible to detect the imaging position accurately.

In a case where the taking lens has an aperture stop whose aperture is variable, it is advisable to provide a controller that keeps the aperture of the aperture stop constant while the plurality of images are being taken. Varying the aperture of the aperture stop results in varying the degree of blurring of the image, and thus affects the detection of the particular portion of the subject in the plurality of images. Thus, keeping the aperture of the aperture stop constant makes the detection of the particular portion easy.

Here, it is advisable to make the controller keep the aperture of the aperture stop fully open while the plurality of images are being taken. The larger the aperture of the aperture stop, the more blurry the image is outside the imaging position. This makes it possible to detect the imaging position accurately.

In a case where an image sensor is used as the image taker, it is preferable that the distance between the taking lens and the image sensor as set when the plurality of images are taken be determined according to the pitch with which pixels are arranged on the image sensor. This helps perform a necessary and sufficient amount of calculation to detect the imaging position of the subject, and thus makes it possible to detect the imaging position accurately and quickly.

It is advisable to use, as the distance between the taking leans and the image sensor, the distance from the principal point of the taking lens to the image sensor. By using the principal point of the taking lens as the reference position, it is possible to detect the imaging position accurately irrespective of the characteristics of the taking lens mounted.

According to another aspect of the present invention, in a program product, a program is recorded to make an imaging position detecting device perform a process including: a step of taking a plurality of images with varying relative distances to a taking lens; a step of correcting differences among the plurality of images that arise while the plurality of images are being taken; a step of detecting a particular portion of a subject in the plurality of images among which differences have been corrected; and a step of detecting the imaging position in which the taking lens images the subject on the basis of the positions of the particular portion detected in the plurality of image and the relative distances. Here, the particular portion of the subject and the differences among the plurality of images are determined as described above.

### BRIEF DESCRIPTION OF THE DRAWINGS

This and other objects and features of the present invention will become clear from the following description, taken in conjunction with the preferred embodiments with reference to the accompanying drawings in which:

FIG. 1 is a block diagram showing an outline of the configuration of the digital camera of a first embodiment of the invention;

FIG. 2 is a diagram showing an example of a multifocus image space;

FIG. 3 is a diagram showing the space focus image obtained by projecting a section of the multifocus image space shown in FIG. 2;

FIG. 4 is a diagram showing the reshaped space focus image obtained by reshaping the space focus image shown in FIG. 3;

FIG. 5 is a flow chart showing a part of the flow of operations performed to detect the imaging position in the digital cameras of the first and second embodiments;

FIG. 6 is a flow chart showing a part, following the part shown in FIG. 5, of the flow of operations performed to detect the imaging position in the digital cameras of the first and second embodiments;

FIG. 7 is a flow chart showing a part, following the part shown in FIG. 6, of the flow of operations performed to detect the imaging position in the digital cameras of the first and second embodiments;

FIG. 8 is a diagram showing an example of the contents of a data table stored in memory in the digital cameras of the first and second embodiments;

FIG. 9 is a diagram showing an example of the contents of another data table stored in memory in the digital cameras of the first and second embodiments;

FIG. 10 is a diagram showing an example of the contents of still another data table stored in memory in the digital cameras of the first and second embodiments;

FIG. 11 is a diagram showing the blocks into which an image is divided for the detection of the amount of movement thereof in the digital cameras of the first and second embodiments;

FIG. 12 is a diagram showing an example of the reshaped space focus image produced by the digital cameras of the first and second embodiments; and

FIG. 13 is a block diagram showing an outline of the configuration of the digital camera of a second embodiment of the invention.

### DESCRIPTION OF THE PREFERRED EMBODIMENTS

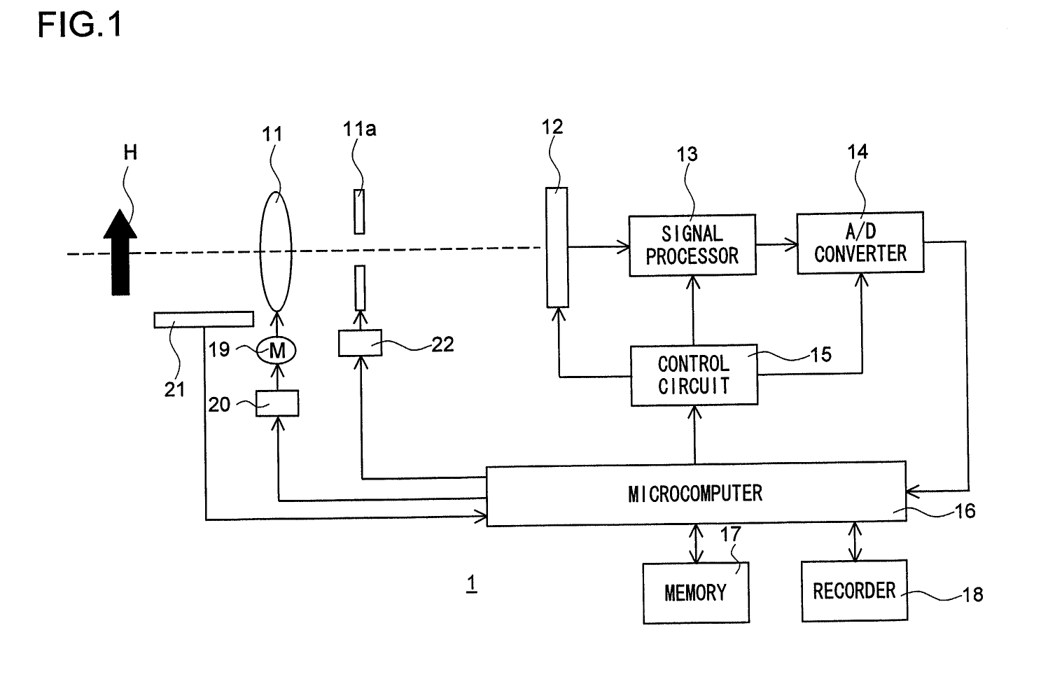

Hereinafter, embodiments of the present invention will be described with reference to the drawings. FIG. 1 shows an outline of the configuration of the digital camera 1 of a first embodiment. The digital camera 1 is provided with a taking lens 11 that is undismountably mounted on the digital camera 1 and an image sensor 12. The taking lens 11 has an aperture stop 11a of which the aperture is variable. The image sensor 12 is an area sensor of a progressive CCD type with 640×480 square pixels.

The digital camera 1 is also provided with a signal processor 13 for processing the analog signal output from the image sensor 12, an A/D converter 14 for converting the analog signal into a digital signal, a control circuit 15 for controlling the image sensor 12, the signal processor 13, and the A/D converter 14, a microcomputer 16 for processing the digital signal from the A/D converter 14 to produce image data representing an image and for controlling the whole digital camera 1, a memory 17 for storing a program executed by the microcomputer 16, a recorder 18 for recording the image data on a removable recording medium, a motor 19, a drive circuit 20 for driving the taking lens 11 through the motor 19, a position detecting circuit 21 for detecting the position of the taking lens 11, and an aperture driver 22 for driving the aperture stop 11a.

The taking lens 11 leads the light from the shooting target area to the image sensor 12. When an image to be recorded is taken, the taking lens 11 images the light from the subject H, which is included in the shooting target area, on the image sensor 12. The image sensor 12 performs photoelectric conversion pixel by pixel, and outputs the accumulated electric charges as a signal that represents the amount of light received. The output signal of the image sensor 12 is subjected to processing, such as correlated double sampling and automatic gain control, by the signal processor 13, is then converted into a 10-bit digital signal by the A/D converter 14, and is then fed to the microcomputer 16. The microcomputer 16 performs various kinds of processing, such as pixel interpolation, white balance adjustment, and gamma correction, on the signal from the A/D converter 14 to produce image data that represents the image taken.

The processing starting with the photoelectric conversion by the image sensor 12 and ending with the signal conversion by the A/D converter 14 is controlled synchronously by the microcomputer 16 through the control circuit 15. The motor 19 is controlled by the microcomputer 16 through the drive circuit 20 to move the taking lens 11 along the optical axis thereof. The position of the taking lens 11 is detected by the position detecting circuit 21, and the microcomputer 16, while monitoring the output signal from the position detecting circuit 21, controls the driving of the motor 19 to move or stop the taking lens 11. The taking lens 11 may be of the type that achieves focus adjustment by moving the whole lens or of the type that achieves it by moving part of the lens.

The aperture stop 11a, with the aperture thereof, restricts the amount of light that is led to the image sensor 12. The aperture of the aperture stop 11a is controlled by the microcomputer 16 through the aperture driver 22.

The digital camera 1 is provided with an AF function that permits the taking lens 11 to be automatically focused on the subject H. The AF function is achieved by detecting the imaging position in which the taking lens 11 images the subject H, then calculating the distance to the subject H on the basis of the detected imaging position and the focal length of the taking lens 11, and then moving the taking lens 11 to the position corresponding to the calculated distance.

Now, how the imaging position in which the taking lens 11 images the subject H is detected will be described in detail.

Multifocus Image Space

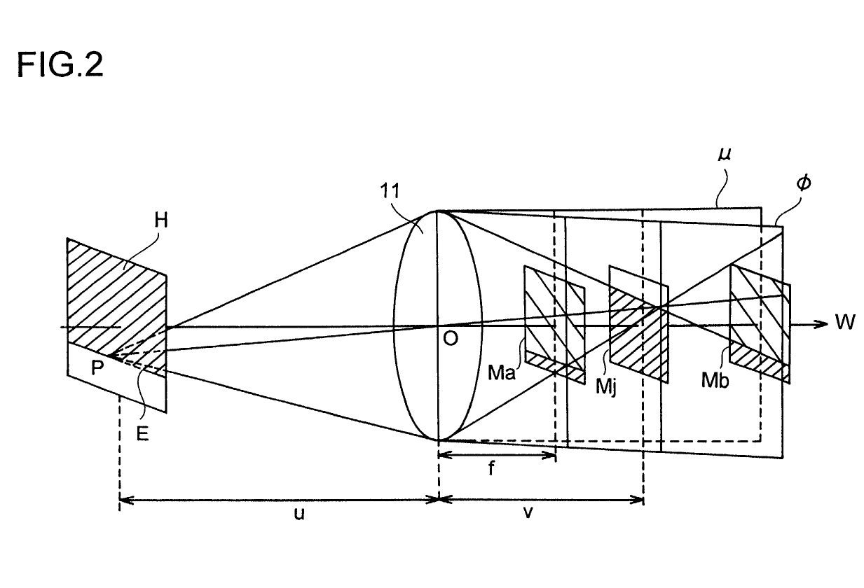

The digital camera 1 takes a plurality of images including the subject H with the taking lens 11 positioned in different positions. The image sensor 12 is kept in a fixed position, and therefore each of the plurality of images is taken with a different distance between the taking lens 11 and the image sensor 12. By arranging those images along the optical axis W (hereinafter referred to as the “focus axis” also) of the taking lens 11, an image space (multifocus image space) as shown in FIG. 2 is produced.

FIG. 2 shows a case where the subject H includes a linear boundary (edge) E across which there is a great difference in brightness, and this edge E is taken in three images Ma, Mj, and Mb. Of these, the first image Ma is taken with the taking lens 11 focused for infinity, and therefore its coordinate w along the focus axis W with respect to the origin located at the principal point O of the taking lens 11 is equal to the focal length f of the taking lens 11. Usually, the subject H is not located at infinity, and therefore the image Ma is taken in a rear-focused state with respect to the subject H.

The second image Mj is taken with the taking lens 11 focused on the subject H, i.e. in sharp focus. Let the coordinate of this image Mj along the focus axis W be v. It is to be noted that the image Mj in sharp focus cannot be taken before the distance to the subject H is known, and therefore, except by chance, there is no image Mj in sharp focus among a plurality of image actually taken. Finding the coordinate v is detecting the imaging position of the subject H. In the digital camera 1, the coordinate v is found in the manner described later.

The third image Mb is taken with the taking lens 11 focused in front of the subject H, i.e. in a front-focused state.

In the multifocus image space, once the position of the sharply focused image Mj, i.e. the coordinate v, is found, the distance u from the taking lens 11 to the subject H is readily calculated according to the basic lens formula given below as Formula 1.

1/f=1/u+1/v Formula 1

In producing the multifocus image space, the following points need to be taken into consideration:

(1) The Coordinates of the Images Along the Focus Axis W

The coordinates of the individual images along the focus axis W are found on the basis of the output of the position detecting circuit 21. In ideal cases, the amount of movement of the taking lens 11 coincides with the amount of movement of the image along the focus axis W, which, however, is often not the case depending on the optical design of the lens. Therefore, the output of the position detecting circuit 21 needs to be converted into the coordinates of the images along the focus axis W.

(2) Correction of the Amount of Movement

In the multifocus image space, a point on the subject H, for example a point P (hereinafter referred to as the “edge point”) on the edge E, the principal point O of the taking lens 11, and the center points of the blurred images of the edge point P in the individual images fall on an identical straight line. However, since the plurality of images are taken at different times, they include relative movements resulting from the movement of the subject H itself and camera shake. To make the center points of the blurred images of the edge point P fall on the identical straight line, it is necessary to correct for the amounts of such relative movements.

(3) Correction of the Size of the Images

Moreover, to make the center points of the blurred images of the edge point P fall on the identical straight line, the coordinates of the individual images along the focus axis W must be proportional to the sizes of what is imaged therein (image heights). However, depending on the optical design of the lens, the coordinates of the images along the focus axis W are often not proportional to the sizes of what is imaged therein. In this case, the sizes of the entire images need to be corrected to establish a proportional relationship. To resize the entire images adequately, it is necessary to make clear the relationship between the coordinates of the images along the focus axis W (or the output of the position detecting circuit 21) and the sizes of what is imaged therein.

It is essential to overcome these problems in order to produce an accurate multifocus image space and to perform accurate focusing on the subject H (how this is achieved in practice will be described later). It is to be noted that the plurality of images need to be taken with other shooting conditions than the position of the taking lens 11 kept constant. That is, the aperture of the aperture stop 11a and the photoelectric conversion time, i.e. electronic shutter speed, of the image sensor 12 are kept constant.

Space Focus Image

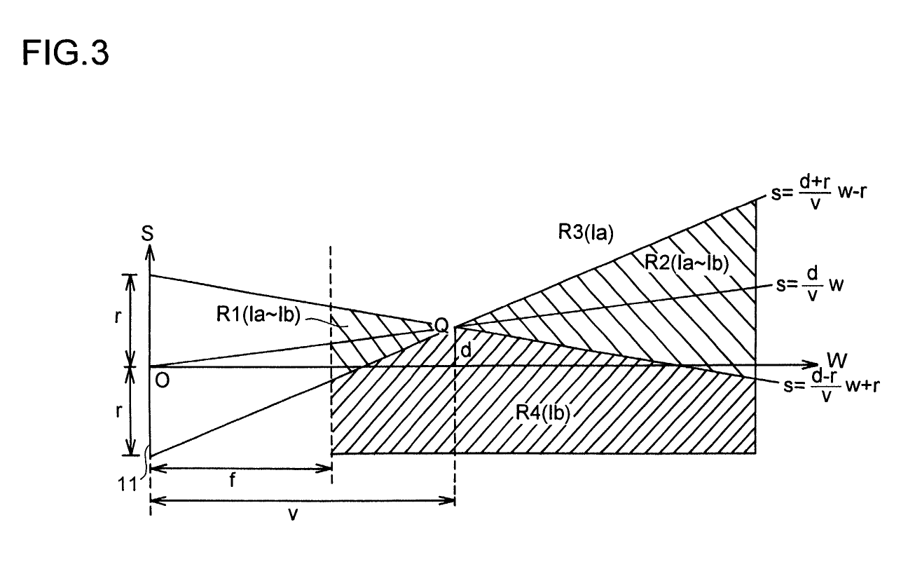

In FIG. 2, consider a plane φ that includes a line PO and that is perpendicular to the image of the linear edge E. When the multifocus image space is cut on this plane φ and the obtained sectional image is projected on a plane μ that includes the focus axis W and that includes the diameter of the taking lens 11 on which the plane φ lies, an image with a brightness distribution as shown in FIG. 3 is obtained. This image will be referred to as the space focus image.

According to Japanese Patent Application Laid-Open No. H10-206150, in the space focus image, lines that pass through the position Q (v,d) in which the in-focus image of the edge point P is formed and that are represented by Formulae 2 to 5 below (in all of which 0<λ<1) are referred to as the equal-brightness lines. Brightness is assumed to be equal at all points on each of these lines, and this is exploited to establish correspondence of equally bright portions between different images.

s=((d−λr)/v)w+λr (where w<v) Formula 2

s=((d+λr)/v)w−λr (where w>v) Formula 3

s=((d+λr)/v)w−λr (where w<v) Formula4

s=((d−λr)/v)w+λr (where w>v) Formula 5

However, the basic properties of a lens dictate that, the greater the coordinate w along the focus axis W, and thus the farther from the taking lens 11, the dimmer the image formed there. Accordingly, to establish correspondence of equally bright portions between different images, the brightness of the individual images need to be corrected according to their coordinates along the focus axis W in such a way that brightness is equal at all points on each of the aforementioned lines.

To achieve this, it is necessary to make clear the relationship between the coordinates of the images along the focus axis W (or the output of the position detecting circuit 21), the aperture of the aperture stop 11a (the apparent aperture value), and the brightness observed on the image sensor 12 (how this is achieved in practice will be described later).

When brightness is corrected properly, an accurate space focus image as shown in FIG. 3 is obtained. An accurate space focus image is divided into the following four regions:

a far-side blurry region R1, where brightness varies in the range from Ia to Ib;

a near-side blurry region R2, where brightness varies in the range from Ia to Ib;

an in-focus brightness region R3, where brightness is uniform at Ia; and

an in-focus brightness region R4, where brightness is uniform at Ib

Now, the lines represented by Formulae 2 to 5 which pass through the position Q (v, d) of the in-focus image of the edge point P are truly what their name, equal-brightness lines, suppose them to be. By finding such equal-brightness lines for different degrees of brightness, it is possible to obtain, as the intersection of those lines, the coordinate v of the sharply focused image along the focus axis W.

Reshaped Space Focus Image

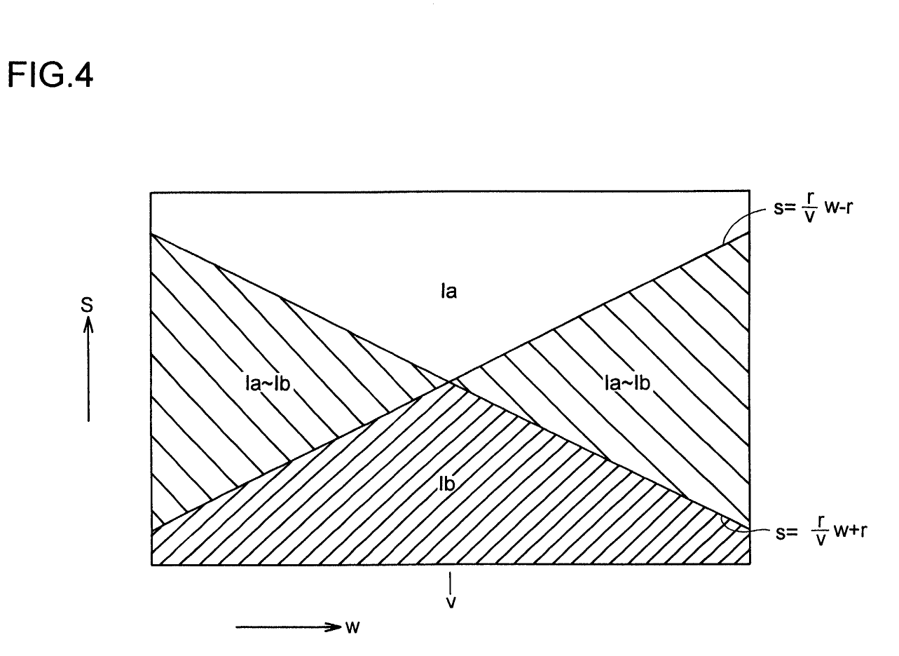

The space focus image shown in FIG. 3 is then reshaped in such a way that a line that passes through the position Q (v, d) of the in-focus image of the edge point P and that is represented by Formula 6 below is aligned with the focus axis W. The reshaped image is referred to as the reshaped space focus image. This reshaped space focus image has a brightness distribution as shown in FIG. 4.

s=(d/v)w Formula 6

After the reshaping, the equal-brightness lines are now represented by Formulae 7 to 10 below. This makes it easier to calculate the coordinate v as their intersection.

s=−(λr/v)w+λr (where w<v) Formula 7

s=(λr/v)w−λr (where w>v) Formula 8

s=(λr/v)w−λr (where w<v) Formula 9

s=−(λr/v)w+λr (where w>v) Formula 10

Edge Detection

Any point on the subject H may be used to obtain the equal-brightness lines, as long as the point can be distinguished easily from its surroundings; a preferred example of such a point is one on an edge, i.e. a boundary between a high-brightness and a low-brightness region. An edge can be detected easily, for example, by the use of a variance image. Then, the position and direction of the edge are detected, and, for each of a few edge points, i.e. points on the edge, the reshaped space focus image is produced, and is analyzed as described above to find the coordinate v, at which lies the in-focus position of each edge point. Then, the average value, median value, RMS (root-mean-square) value, or the like of the coordinates thus found is calculated as the coordinate of the imaging position of the subject H.

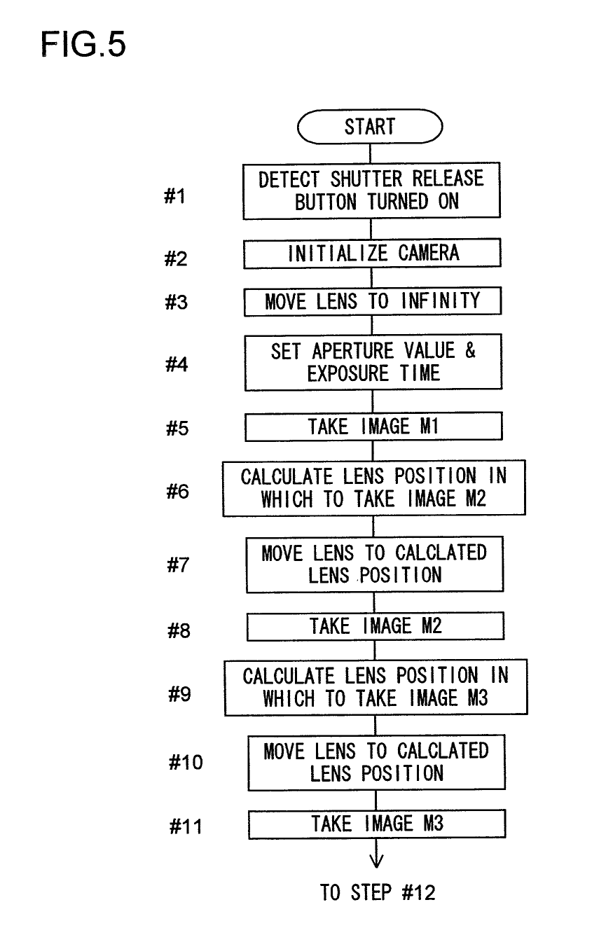

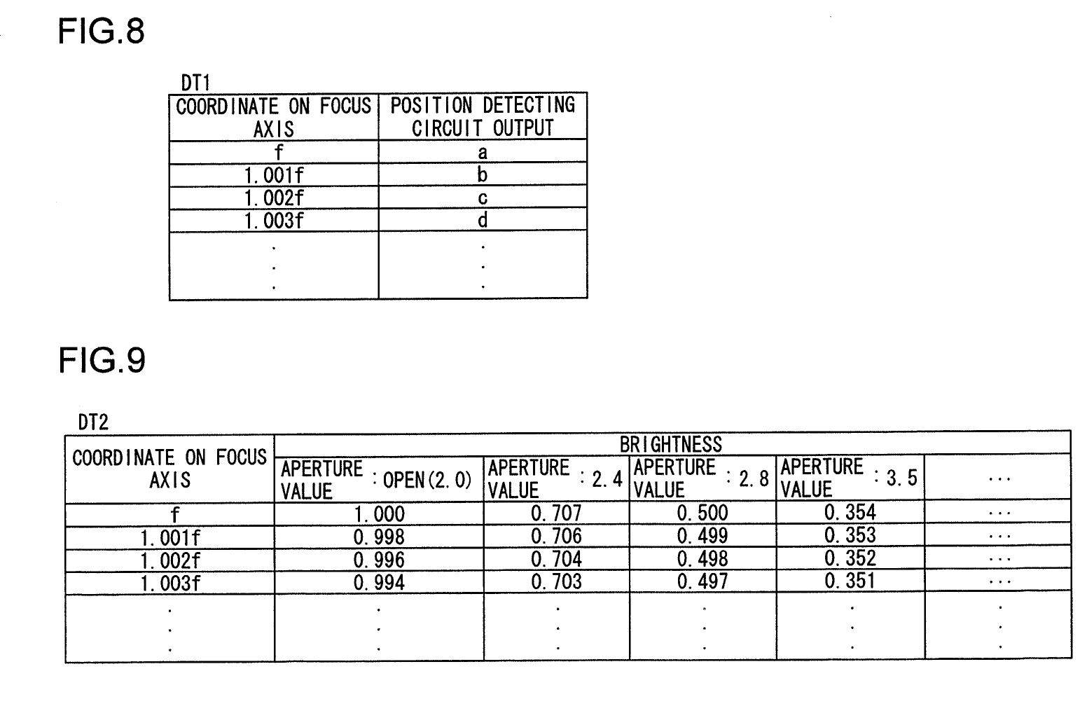

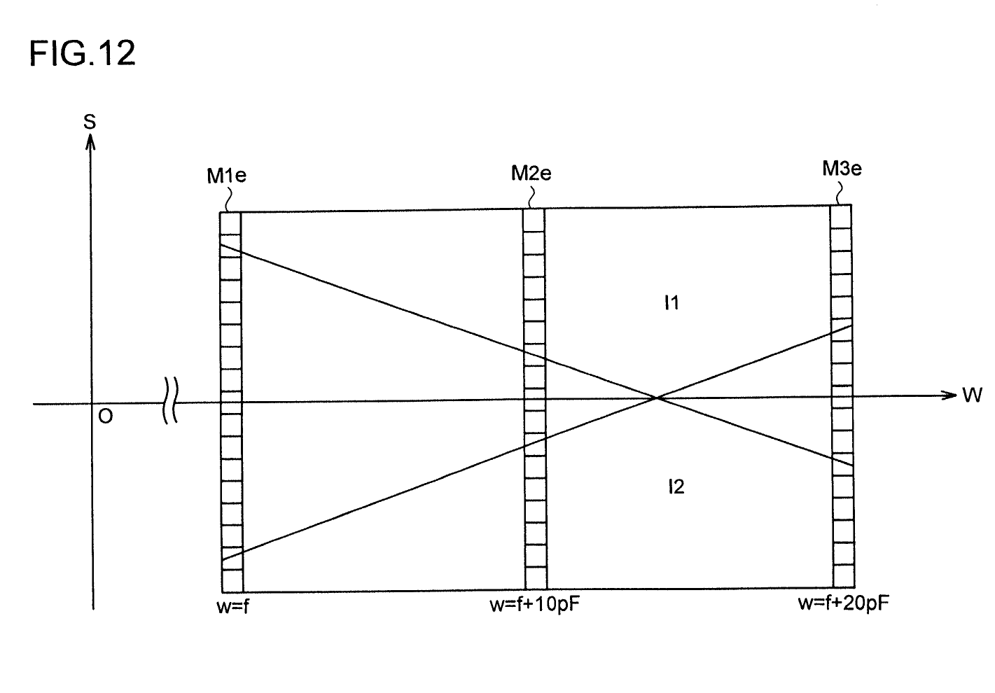

Now, the flow of operations performed to detect the imaging position of the subject H in the digital camera 1 will be described with reference to flow charts in FIGS. 5 to 7, tables in FIGS. 8 to 10, and diagrams in FIGS. 11 and 12. This flow of operations is executed by the microcomputer 16 according to various programs, including one for detecting the imaging position, stored in the memory 17.

Shooting of the Subject

When a shutter release button (not shown) provided in the digital camera 1 is detected being operated to the ON position (FIG. 5, step #1), the portions of the digital camera 1 relevant to shooting are initialized (#2). For example, the accumulated electric charges remaining in the image sensor 12 are discharged therefrom. Next, while the output signal of the position detecting circuit 21 is being monitored, the motor 19 is controlled so that the taking lens 11 is moved so as to be focused for infinity (#3). What output the position detecting circuit 21 yields when the taking lens 11 is focused for infinity is stored in the memory 17.

Then, with the aperture of the aperture stop 11a fully open (set at its maximum aperture) and with the exposure time (electronic shutter speed) set at a predetermined value, an image is taken, and image data representing the image is produced. On the basis of the signal intensity of the image data produced, the aperture of the aperture stop 11a and the exposure time that are adequate for the subject H are determined (#4). Here, the aperture stop 11a is usually set at its maximum aperture. However, in a case where even the minimum exposure time that can be set will result in overexposure, the aperture stop 11a is set at a smaller aperture.

After the exposure conditions have been set, a first image M1 including the subject H is taken, and the image data thereof is produced (#5). The aperture value of the aperture stop 11a and the exposure time of the image sensor 12 at this moment are stored. Next, as the value corresponding to the position of the taking lens 11 in which to take a second image M2, the coordinate P2 of the image M2 along the focus axis W is calculated (#6). This calculation is performed according to Formula 11 below. Here, P1 represents, as the value corresponding to the position of the taking lens 11 in which the first image M1 was taken, the coordinate of the image Ma along the focus axis W, p represents the pitch with which pixels are arranged on the image sensor 12, and F represents the aperture value (the focal length f of the taking lens 11 divided by the aperture of the aperture stop 11a) of the aperture stop 11a.

P2=P1+10pF Formula 11

The conversion of the output of the position detecting circuit 21, which represents the position of the taking lens 11, into the coordinate of the image along the focus axis W is performed with reference to a data table DT1 as shown in FIG. 8 stored in the memory 17. In FIG. 8, the values in the left column are coordinates of the image along the focus axis W with respect to the origin located at the principal point 0 of the taking lens 11, and the values in the right column are output values of the position detecting circuit 21. The coordinates in the left column are given in relative values using the focal length f of the taking lens 11 as the unit, and the value that corresponds to the position of the taking lens 11 set in step #3 equals 1f.

That is, Formula 11 is equivalent to Formula 12 below, and therefore what is performed in step #6 is to find, in the data table DT1, the value in the right column that corresponds to the value in the left column that equals to the value of Formula 12.

P2=f+10pF Formula 12

Next, while the output of the position detecting circuit 21 is being monitored, the motor 19 is controlled so that the taking lens 11 is moved to the position corresponding to P2 in Formula 12 (#7). Then, the second image M2 is taken, and the image data thereof is produced (#8). When this image is taken, the aperture value of the aperture stop 11a and the exposure time of the image sensor 12 are set at the same values as in step #5.

After the second image M2 has been taken, as the value corresponding to the position of the taking lens 11 in which to take a third image M3, the coordinate P3 of the image M3 along the focus axis W is calculated (#9). This calculation is performed according to Formula 13 below.

P3=P2+10pF Formula 13

That is, P3 is calculated according to Formula 14 below, and therefore what is performed in step #9 is to find, in the data table DT1 shown in FIG. 8, the value in the right column that corresponds to the value in the left column that equals to the value of Formula 14.

P3=f+20pF Formula 14

Next, while the output of the position detecting circuit 21 is being monitored, the motor 19 is controlled so that the taking lens 11 is moved to the position corresponding to P3 in Formula 14 (#10). Then, the third image M3 is taken, and the image data thereof is produced (#11). When this image is taken, the aperture value of the aperture stop 11a and the exposure time of the image sensor 12 are again set at the same values as in step #5.

In this way, three images M1, M2, and M3 are taken with the taking lens 11 positioned in different positions, and thus a multifocus image is obtained. Naturally, the positions of the images M1 to M3 along the focus axis W are now definitely known.

As described above, the coordinates P1, P2, and P3 of the three images M1, M2, and M3 thus taken along the focus axis W with respect to the origin located at the principal point O of the taking lens 11 lie at intervals of 10pF. These intervals are set so that, when the image M2 is in focus as in the example shown in FIG. 2, the blurred image of a point has a width of 10p in the images M1 and M3. Given the number of pixels provided on the image sensor 12, this setting is adequate in that it permits the coordinate v to be detected with satisfactory accuracy and simultaneously eliminates the trouble of performing more calculations than are necessary to secure sufficient accuracy.

Correction of Brightness

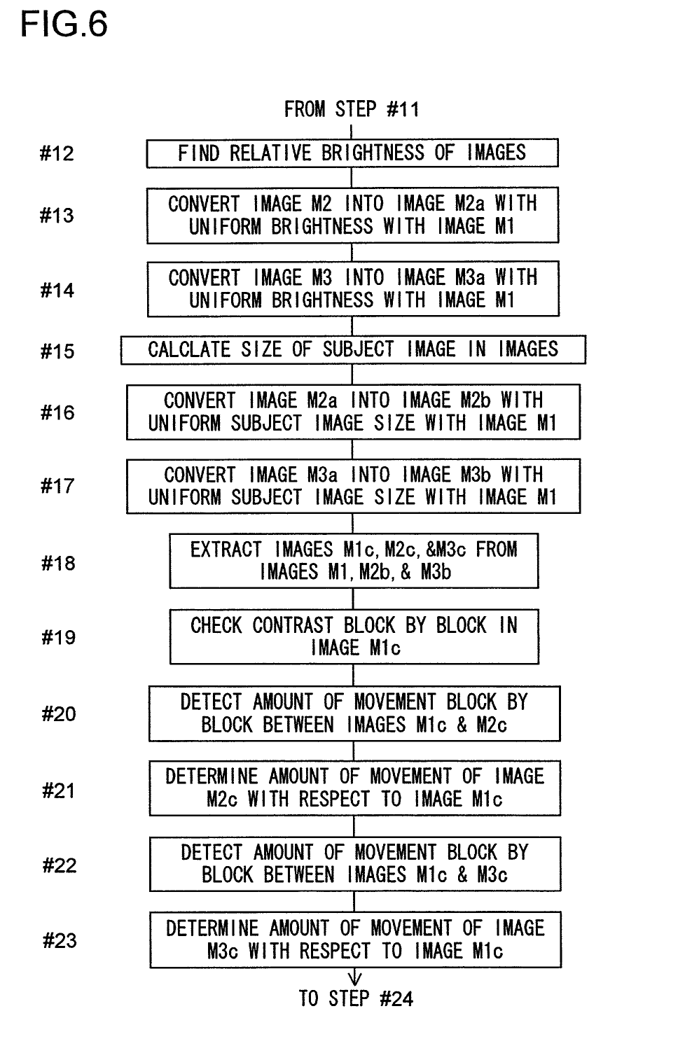

As described earlier, to obtain an accurate space focus image, to correct the amount of movement, and to detect an edge, it is necessary to correct the brightness of the images. Therefore, the relative brightness of the three images taken (i.e. the ratio of the signal strength of their image data) is found (FIG. 6, step #12).

For this purpose, the relationship between the coordinates of the images along the focus axis W, the aperture value of the aperture stop 11a, and the brightness observed on the image sensor 12 are stored in the form of a data table DT2 as shown in FIG. 9 in the memory 17. The data table DT2 is so prepared as to cope with different aperture values; specifically, the values in the leftmost column are coordinates of the images along the focus axis W, and the values in the other columns are brightness values corresponding to the coordinates in the leftmost column as classified according to the aperture value. Here, as in the data table DT1, the coordinates in the leftmost column are given in relative values using the focal length f of the taking lens 11 as the unit.

In step #12, on the basis of the aperture values with which the images M1 to M3 were taken, the brightness I1 to I3 corresponding to the coordinates of those images M1 to M3 is found in the data table DT2.

Next, on the basis of the brightness I1 and I2 thus found, the brightness of the image M2 is corrected to obtain a new image M2a (#13). Specifically, the brightness of the image M2 (the signal intensity of the image data of the image M2) is multiplied by I1/I2. Likewise, the brightness of the image M3 is multiplied by I1/I3 to obtain a new image M3a (#14). In this way, three images M1, M2a, and M3a are obtained in which differences in brightness resulting from different distances from the taking lens 11 have been corrected for and that thus have uniform brightness.

Detection and Correction of the Amount of Movement

After the brightness of the images has been made uniform, the movement of the subject among them is corrected for. For this purpose, the amount of movement is detected through correlation calculation of the brightness of the images. Here, it is to be noted that, even if the subject is completely at rest and the digital camera 1 is completely at rest by being secured to a tripod or the like, the three images are not identical. This is because the three images are taken with the taking lens 11 positioned in different positions and therefore the same subject appears with different degree of blurring therein.

Therefore, it is difficult to detect the amount of movement correctly through correlation calculation of brightness alone, but still correlation calculation is performed for the purpose of minimizing the amount of movement. The amount of movement is detected at a resolution of a multiple of the pixel pitch rounded off to the nearest integer number. This is because, as described above, it is difficult to detect the amount of movement accurately and the accuracy of the decimal portion of the detected value is not guaranteed.

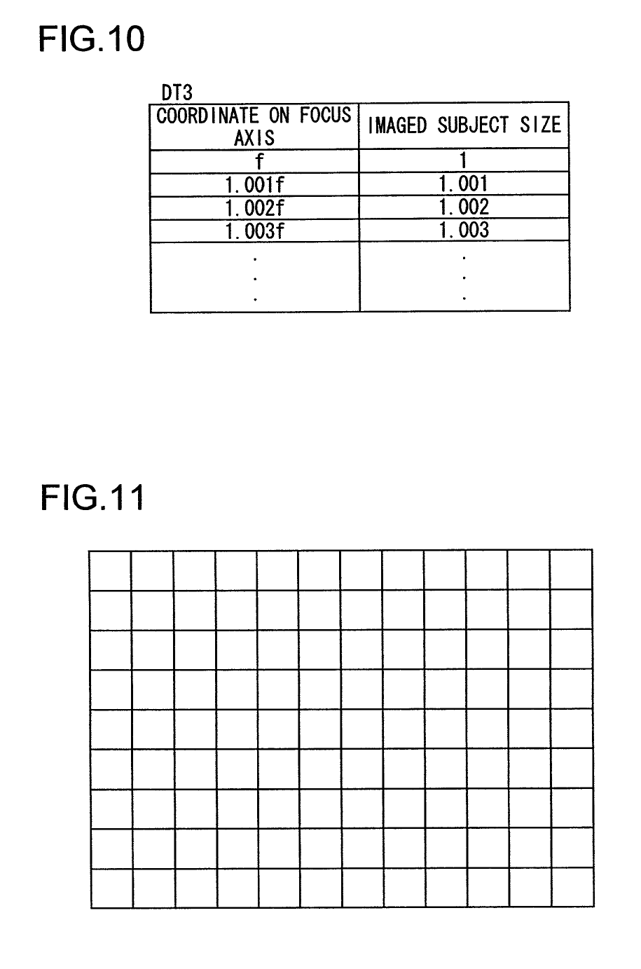

As a process to go through before correlation calculation, the sizes of what is imaged in the individual images are corrected. Specifically, the sizes of the images M2a and M3a themselves are modified so that the sizes of what is imaged therein are equal to the size of what is imaged in the image M1. First, the size of what is imaged in each image is calculated (#15). The relationship between the coordinates of the images along the focus axis W and the size of what is imaged therein is stored in the form of a data table DT3 as shown in FIG. 10 in the memory 17. In FIG. 10, the values in the left column are coordinates of the images along the focus axis W, and the values in the right column are values representing the size of what is imaged therein. Here also, the coordinates are given in relative values using the focal length f of the taking lens 11 as the unit. The sizes β1, β2, and β3 corresponding to the coordinates of the images M1, M2a, and M3a are found in the right column. In this case, β1=1.

Next, the size of the image M2a is modified to obtain an image M2b of which the size is identical with that of the image M1 (#16). After the modification of its size, the image M2b has 640×β1/β2 pixels horizontally and 480×β1/β2 pixels vertically. Then, likewise, by using β3 instead of β2, the size of the image M3a is modified to obtained an image M3b (#17). The sizes of the images can be modified by a known method such as a bilinear method.

After the modification of size, the number of pixels of the three images are made equal by extracting portions thereof (#18). For example, from a central portion of each of the images M1, M2b, and M3b, a region having 600×450 pixels is extracted. In this way, three images M1c, M2c, and M3c are obtained that are uniform in brightness, in the size of what is imaged therein, and the number of pixels.

Next, for the detection of the amount of movement, the image M1c is divided into 12×9 block each having 50×50 pixels as shown in FIG. 11. Then, block by block, horizontal contrast and vertical contrast are calculated to check whether each block is suitable for the detection of the amount of movement or not (#19). If horizontal or vertical contrast is found to be below a predetermined level in any block, that block is judged to be unsuitable.

Then, between the images M1c and M2c, correlation calculation of signal strength is performed block by block, to detect the amount of movement in each block (#20). The correlation calculation here is performed by calculating the sum (correlation value) of the absolute values of the differences between the signal values of the individual pixels included in a given block of the image M1c and the signal values of the individual pixels included in the corresponding block of the image M2c. Specifically, 121 correlation values in total are calculated while, with respect to a given block (50×50 pixels) of the image M1c, the position of the corresponding 50×50 pixels of the image M2c is shifted ±5 pixels horizontally or vertically at a time, and then the amount of shifting that yields the least correlation value is given as the amount of movement.

However, when the least correlation value exceeds a predetermined value, the given block is judged to be unsuitable for the detection of the amount of movement. A correlation value exceeding the predetermined value results when the amount of movement exceeds ±5 pixels or when different portions of a block move in different manners (for example, when the block includes both a subject at rest and a subject in motion).

After the amount of movement is calculated in each block, the average value of the amounts of movement obtained in all the blocks except those judged to be unsuitable are calculated, and the resulting value is given as the amount of movement of the image M2c as a whole with respect to the image M1c (#21). If the images include subjects that move in different manners, the amount of movement varies greatly from one block to another. In this case, the average value is calculated by using only blocks that include a subject that moves in similar manners, i.e. blocks in which similar amounts of movement are detected. Moreover, the average value is calculated by using as many blocks as possible so that the subject used to calculate the average value occupies as large an area as possible in the images.

For example, a three-dimensional histogram is created with the amount of movement taken along the x and y axes and the number of blocks taken along the z axis, and the amount of movement to which the largest number of blocks belong is given as the amount of movement of the image as a whole. Alternatively, the average value is calculated by using only blocks located within about ±2 pixels of the amount of movement to which the largest number of blocks belong, and the resulting average value is rounded off to the nearest integer number to give the amount of movement of the image as a whole. By calculating the average value in this way, even when part of the image includes a subject that moves in a different manner from the subject in the other part, such a differently moving subject does not affect the amount of movement of the image as a whole.

Then, in the same manner as in steps #20 and #21, the movement of the image M3c with respect to the image M1c is detected (#22 and #23).

Detection of an Edge

After the detection of the amount of movement, an edge is detected by a method using a variance image. A variance image is produced from the three images that have been so corrected that the center points of the blurred images of an edge point P lie at identical coordinates therein. This requires not only the correction of the amount of movement and the correction of the size of what is imaged, but also the correction of brightness. Therefore, the three images M1c, M2c, and M3c obtained in step #18 are further corrected for the amounts of movement detected in steps #21 and #23.

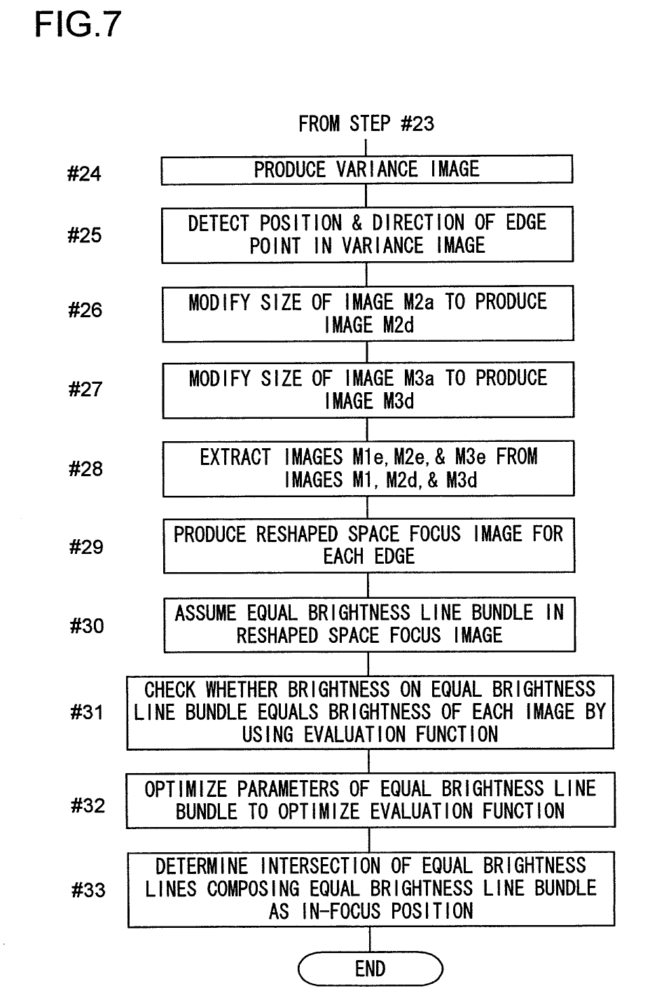

First, a variance image is produced from the images M1c, M2c, and M3c (FIG. 7, step#24). Let the amount of movement of the image M2c with respect to the image M1c be (x12, y12), and let the amount of movement of the image M3c with respect to the image M1c be (x13, y13). The signal value at the coordinates (x, y) in the variance image equals the variance of

the signal value at the coordinates (x, y) in the image M1c,

t he signal value at the coordinates (x+x12, y+y12) in the image M2c, and

the signal value at the coordinates (x+x13, y+y13) in the image M3c.

No signal value is assumed to be available at coordinates at which no signal values exist for the pixels of the images M2c and M3c (for example, when x+x12<0 or y+y13>450) and therefore no variance can be calculated.

Next, in the variance image, the position and direction of an edge are detected (#25). At coordinates at which no signal value is available, this edge detection is not performed. Moreover, the amounts of movement detected block by block in steps #20 and #22 are checked so that edge detection is performed only for the pixels included in blocks that yielded the amounts of movement that do not differ greatly from the amount of movement of the image as a whole. This prevents edge detection from being performed for a differently moving subject included in only part of the image, and thus helps prevent erroneous detection.

Producing the Multifocus Image Space

As described earlier in the description of steps #3 to #11, the coordinates P1, P2, and P3 of the images M1, M2, and M3 along the focus axis W in the multifocus image space are P1=f, P2=f+10pF (Formula 12), and P3=f+20pF (Formula 14). Moreover, as described earlier, a proportional relationship must be established between the coordinates of the images along the focus axis W and the sizes of what is imaged therein. That is, let the sizes of the images M1, M2, and M3 be L1, L2, and L3 respectively, then Formula 15below must hold.

L1:L2:L3=f:f+10pF:f+20pF Formula 15

In reality, however, the relationship represented by Formula 16 below holds, and therefore the sizes of the images need to be modified.

L1:L2:L3=β1:,β2:β3 Formula 16

First, the size of the image M2a, of which the brightness has been made uniform with the other two, is modified to obtain an image M2d (#26). Specifically, the size of what is imaged therein is magnified at a factor of β1/β2×(1+10pF/f). The image M2d has 640×β1/β2×(1+10pF/f) pixels horizontally and 480×β1/β2×(1+10pF/f) pixels vertically.

Likewise, the size of the image M3a is modified to obtain an image M3d (#27). The image M3d has 640×β1/β3×(1+20pF/f) pixels horizontally and 480×β1/β3×(1 +20pF/f) pixels vertically.

Next, the amounts of movement are corrected for. The correction here is achieved by moving the images M2d and M3d translationally by using the amounts of movement used in step #24.

Specifically, for example, a region having 600×450 pixels is extracted from each of the images M1, M2d, and M3d to obtain images M1e, M2e, and M3e (#28). These images are extracted in such a way that, if the amounts of movement of the images M2c and M3c with respect to the image M1c are assumed to be (x12, y12) and (x13, y13) respectively as mentioned earlier, the centers of the extracted images coincide,

for the image M1, the center thereof,

for the image M2d, the point (x12, y12) away from the center thereof, and,

for the image M3d, the point (x13, y13) away from the center thereof

As a result, the edge point P on the subject H, the principal point O of the taking lens 11, and the centers of the three images M1e, M2e, and M3e fall on an identical straight line.

This will be explained further with specific coordinates. Within each image (having 600×450 pixels), let the coordinates of the pixel at the upper left-hand comer be (0, 0), let the coordinates of the pixel at the upper right-hand comer be (599, 0), let the coordinates of the pixel at the lower left-hand comer be (0, 449), and let the coordinates of the pixel at the lower right-hand comer be (599, 449). Then, the coordinates of the intersection between each image and the focus axis W are (299.5, 224.5).

Let the coordinates of the center point of the blurred image of the edge point P formed in the image M1e be (x, y), then the coordinates of the center point of the blurred image of the edge point P formed in the image M2e are

((x−299.5)×(1+10pF/f)+299.5,(y−224.5)×(1−10pF/f)+224.5),

and

the coordinates of the center point of the blurred image of the edge point P formed in the image M3e are

((x−299.5)×(1+20pF/f)+299.5, (y−224.5)×(1+20pF/f)+224.5).

Producing the Reshaped Space Focus Image

For each edge detected in step #25 (i.e. for the center point of the blurred image of each edge point formed in the image M1e), a reshaped space focus image as shown in FIG. 12 is produced (#29). For example, suppose that the image M1e includes the blurred image of an edge as shown in FIG. 2 of which the brightness varies vertically, and that an edge point (the center point of the blurred image) belonging thereto is detected at coordinates (x1, y1). Then, the coordinates of the pixels of the image M1e that will be included in the reshaped space focus image produced for that edge point are, if the number of pixels of the reshaped space focus image in the direction S is assumed to be 17,

from (x1, y1−8) to (x1, y1+8).

The coordinates of the center point of the blurred image of this edge point formed in the image M2e are

((x1−299.5)×(1+10pF/f)+299.5, (y1−224.5)×(1+10pF/f)+224.5).

For simplicity's sake, these coordinates are rounded off to the nearest integer numbers; that is, they are given by

x2=int ((x1−299.5)×(1+10pF/f)+300)

and

y2=int ((y1−224.5)×(1+10pF/f)+225).

Then, the coordinates of the pixels of the image M2e that will be included in the reshaped space focus image are

from (x2, y2−8) to (x2, y2+8).

Likewise, if it is assumed that

x3=int ((x1−299.5)×(1+20pF/f)+300)

and

y3=int ((y1−224.5)×(1+20pF/f)+225),

then the coordinates of the pixels of the image M3e that will be included in the reshaped space focus image are

from (x3, y3−8) to (x3, y3+8).

FIG. 12 shows an example of the reshaped space focus image obtained by arranging the signal values of these 17×3, i.e. 51, pixels.

In the reshaped space focus image thus obtained, an equal-brightness line bundle composed of a plurality of equal-brightness lines is assumed (#30). Then, whether the brightness at each point on the equal-brightness line bundle equals the brightness of each image or not is evaluated by using predetermined evaluation function (#31). Then, the parameters of the equal-brightness line bundle are optimized to optimize the evaluation function (#32), and the intersection of the equal-brightness lines composing the equal-brightness line bundle is determined as the in-focus position (#33). In this way, the coordinate v of the in-focus position of the edge point along the focus axis W is found.

The operations in steps #29 to #33 are performed for each edge detected in each image in step #25 so that the in-focus position of each edge point is determined. Now, the detection of focus is complete for all the images.

Detection Accuracy

In FIG. 12, the coordinate of the in-focus position is v=f+14pF, and the widths of the blurred images formed in the three images M1e, M2e, and M3e are 14p, 4p, and 6p respectively. As mentioned earlier, the three images lie at intervals of 10pF along the focus axis W. This is set so as to fit the 17-pixel width of the reshaped space focus image in the direction S. If the images lie at longer intervals, the blurred images formed therein will have too large widths; if the images lie at shorter intervals, the blurred images formed therein will have too small widths. In either case, the in-focus position v is detected with lower accuracy.

Now, the relationship between the detection error in the in-focus position v along the focus axis W and the aperture value when the images are taken will be described. As examples, consider the following two sets of conditions A and B.

Conditions A:

Aperture value with which the images are taken

F=2.8

Coordinate of the image M1

P1=f

Coordinate of the image M2

P2=f+10pF=f+28p

Coordinate of the image M3

P3=f+20pF=f+56p

In-focus position

v=f+14pF=f+39.2p

Conditions B:

Aperture value with which the images are taken

F=5.6

Coordinate of the image M1

P1=f

Coordinate of the image M2

P2=f+10pF=f+56p

Coordinate of the image M3

P3=f+20pF=f+112p

In-focus position

v=f+14pF=f+78.4p

Comparison between the conditions A and B shows the following. The widths of the blurred images in the reshaped space focus image are 14p, 4p, and 6p respectively and equal under both the conditions A and B. When the widths of the blurred images are equal in this way, the detection error in the in-focus position v is considered to be proportional to the intervals between the images. Specifically, when F=5.6 (the images lie at intervals of 56p), the intervals along the focus axis W are twice as long and therefore the detection error in the in-focus position v is twice as large as when F=2.8 (the images lie at intervals of 28p).

Moreover, if it is assumed that, when F=5.6, the image lie at intervals of 28p, then the blurred images formed in the individual images have too small widths as described above, and therefore the in-focus position is detected with lower accuracy.

Thus, it is believed that, the smaller the aperture value (i.e. the larger the aperture of the aperture stop) with which the images are taken, the shorter the intervals between the images, and therefore the higher the detection accuracy of the in-focus position v. To increase the detection accuracy, it is preferable to fully open the aperture stop as described earlier in connection with step #4.

Coping with a Zoom Lens

The taking lens 11 may be a zoom lens of which the focal length is variable. In this case, a focal length detecting circuit for detecting the focal length at which the zoom lens is currently set is additionally provided, and different sets of the data tables DT1, DT2, and DT3 described earlier are prepared for different focal lengths. Then, the above-described flow of operations for detecting the imaging position applies as it is.

The Number of Images Used to Produce the Multifocus Image Space

Here, three images are used to produce a multifocus image space. However, it is also possible to produce a multifocus image space from two images. In that case, equal-brightness lines cannot be determined unequivocally, and a plurality of intersections are obtained between the equal-brightness lines. However, by selecting an intersection common to a few edge points, it is easy to obtain the correct intersection that represents the imaging position. It is also possible to produce a multifocus image space from four or more images. This increases the accuracy of the equal-brightness lines and thus the accuracy of the imaging position detected.

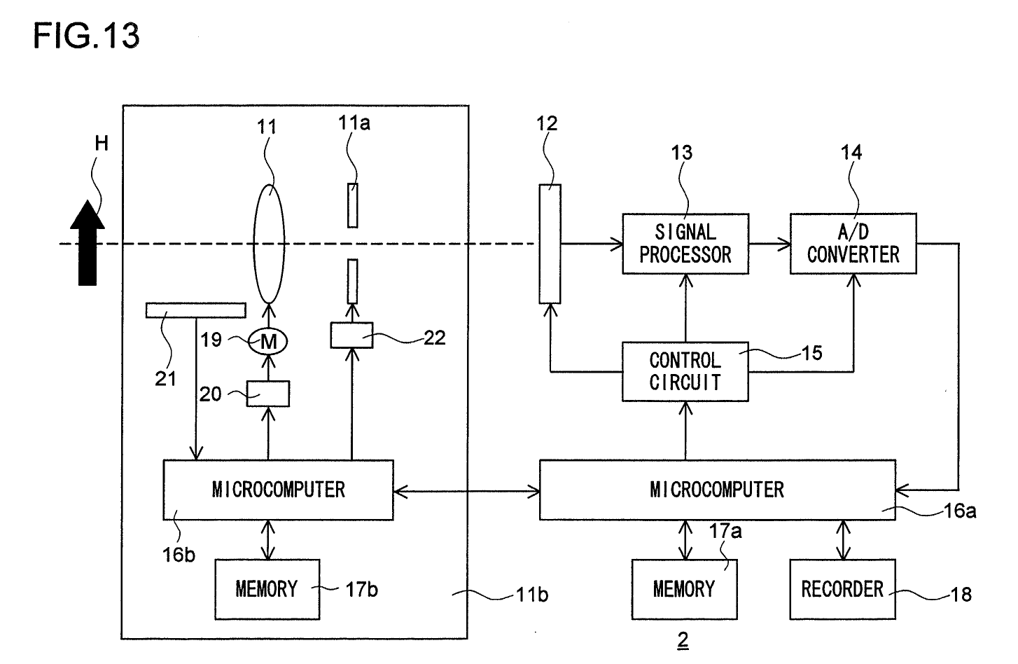

FIG. 13 shows an outline of the configuration of the digital camera 2 of a second embodiment of the invention. In this digital camera 2, the taking lens 11 is interchangeable. Of the constituent components described in connection with the first embodiment, the image sensor 12, signal processor 13, A/D converter 14, control circuit 15, and recorder 18 are provided inside the camera body, and the aperture stop 11a, motor 19, drive circuit 20, position detecting circuit 21, and aperture driver 22 are provided inside the lens barrel 11b of the taking lens 11.

Whereas the digital camera 1 of the first embodiment is provided with one microcomputer 16 and one memory 17, the digital camera 2 of this embodiment is provided with two microcomputers 16a and 16b and two memories 17a and 17b. The microcomputer 16a and the memory 17a are provided inside the camera body, and the microcomputer 16b and the memory 17b are provided inside the lens barrel 11b. The microcomputer 16b performs, of the various kinds of control performed by the microcomputer 16 in the digital camera 1, those related to the taking lens 11, and the microcomputer 16a performs the rest, and in addition controls the generation of image data and the detection of the imaging position of the subject H.

In the memory 17b are stored, in addition to the program for controlling the taking lens 11, the focal length and other characteristics of the taking lens 11, the range within which the aperture of the aperture stop 11a is variable, and the data tables DT1, DT2, and DT3 shown in FIGS. 8 to 10. On the other hand, in the memory 17a are stored, in addition to the program for other control than that related to the taking lens 11, the above-described program for detecting the imaging position.

When the lens barrel 11b is mounted on the camera body, the microcomputers 16a and 16b are automatically connected together via unillustrated contacts. The microcomputers 16a and 16b, while communicating with each other, control the whole digital camera 2. Immediately after the lens barrel 11b is mounted, the microcomputer 16b reads the characteristics of the taking lens 11, the range within which the aperture of the aperture stop 11a is variable, and the data tables DT1, DT2, and DT3 from the memory 17b, and transmits them to the microcomputer 16a. Moreover, whenever the taking lens 11 is driven, the microcomputer 16b transmits the output signal of the position detecting circuit 21 to the microcomputer 16a.

Thus, in the digital camera 2, despite the interchangeable taking lens 11, the imaging position of the subject H can be detected by performing the same flow of operations as in the digital camera 1. In addition, since the taking lens 11 is interchangeable, the user can use taking lenses of varying focal lengths. This enhances the usability of the camera.

Although the first and second embodiments described above deal with digital cameras, the present invention is applicable also to video cameras that use analog signals to represent images, and even to distance measuring devices that simply measure the distance to an object without the purpose of recording an image. Moreover, instead of varying the distance between the taking lens and the image sensor by keeping the image sensor in a fixed position and moving the taking lens as practiced in the embodiments, it is also possible to vary the distance between the taking lens and the image sensor by, conversely, keeping the taking lens in a fixed position and moving the image sensor. Either way, by using the principal point of the taking lens as the reference position for the detection of the imaging position, i.e. the origin on the focus axis, it is possible to detect the imaging position accurately.

Obviously, many modifications and variations of the present invention are possible in light of the above teachings. It is therefore to be understood that within the scope of the appended claims, the invention may be practiced other than as specifically described.

What is claimed is:

1. An imaging position detecting device comprising:
an image taker for taking a plurality of images with varying relative distances to a taking lens;
a corrector for correcting differences among the plurality of images that arise while the plurality of images are being taken;
a first detector for detecting a particular portion of a subject in the plurality of images as corrected by the corrector; and
a second detector for detecting an imaging position in which the taking lens images the subject on a basis of positions of the particular portion in the plurality of image as detected by the first detector and the relative distances.

2. An imaging position detecting device as claimed in claim 1,
wherein the particular portion detected by the first detector is a portion that appears with identical brightness in the plurality of images.

3. An imaging position detecting device as claimed in claim 1,
wherein the particular portion detected by the first detector is a portion that exhibits much variation in brightness among the plurality of images.

4. An imaging position detecting device as claimed in claim 1,
wherein the differences among the plurality of images are differences in position of the subject that result from variation of positions of the subject and the taking lens relative to each other.

5. An imaging position detecting device as claimed in claim 4,
wherein the corrector finds correlation among the plurality of images and, on a basis of the correlation found, corrects the differences in position of the subject among the plurality of images.

6. An imaging position detecting device as claimed in claim 5,
wherein the corrector first corrects differences in size of the subject among the plurality of images that result from the varying relative distances to the taking lens, and then corrects the differences in position of the subject among the plurality of images.

7. An imaging position detecting device as claimed in claim 6,
wherein the corrector finds correlation among the plurality of images among which differences in size of the subject have been corrected and, on a basis of the correlation found, corrects the differences in position of the subject among the plurality of images.

8. An imaging position detecting device as claimed in claim 1,
wherein the differences among the plurality of images are differences in size of the subject that result from the varying relative distances to the taking lens.

9. An imaging position detecting device as claimed in claim 1,
wherein the differences among the plurality of images are differences in brightness that result from the varying relative distances to the taking lens.

10. An imaging position detecting device as claimed in claim 1,
wherein the corrector corrects the differences among the plurality of images according to information on characteristics of the taking lens.

11. An imaging position detecting device as claimed in claim 10,
wherein the taking lens is dismountably mounted on the imaging position detecting device.

12. An imaging position detecting device as claimed in claim 1,
wherein the taking lens has an aperture stop whose aperture is variable, and the imaging position detecting device further comprises a controller for keeping the aperture of the aperture stop constant while the plurality of images are being taken.

13. An imaging position detecting device as claimed in claim 12,
wherein the controller keeps the aperture of the aperture stop fully open while the plurality of images are being taken.

14. An imaging position detecting device as claimed in claim 1,
wherein the image taker is an image sensor, and a distance between the taking lens and the image sensor as set when the plurality of images are taken is determined according to a pitch with which pixels are arranged on the image sensor.

15. An imaging position detecting device as claimed in claim 14,
wherein the distance between the taking leans and the image sensor is a distance from a principal point of the taking lens to the image sensor.

16. A program product in which a program is recorded to make an imaging position detecting device perform a process comprising:
a step of taking a plurality of images with varying relative distances to a taking lens;
a step of correcting differences among the plurality of images that arise while the plurality of images are being taken;
a step of detecting a particular portion of a subject in the plurality of images among which differences have been corrected; and
a step of detecting an imaging position in which the taking lens images the subject on a basis of positions of the particular portion detected in the plurality of image and the relative distances.
